(19) United States
(12) Patent Application Publication
(10) Pub. No.: US 2003/0033317 A1
(43) Pub. Date: Feb. 13, 2003

(54) METHODS AND APPARATUS FOR INTERFACING APPLICATION PROGRAMS WITH DATABASE FUNCTIONS

(76) Inventor: ROBERT ZIGLIN, PHOENIX, AZ (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/274,581

(22) Filed: Mar. 23, 1999

(51) Int. Cl. G06F 7/00

(52) U.S. Cl. 707/102

(57) ABSTRACT

A system for interfacing application programs with a database. The system preferably comprises at least one application program adapted to communicate with a first database type, a database of a second database type, and a layering application program in communication between the application program and the database of a second database type. Preferably, the layering application program is for facilitating communication between the application program and the database of a second database type. The application program is adapted to access data in a database of the first database type using first database access commands adapted for communication with the first database type. In addition, the database of a second database type preferably is accessed by application programs using second database access commands adapted for communication with the second database type. The layering application program preferably converts the first database access commands from the application program to the second database access commands, so that the application program can access data in said database of the second database type. In addition, layering application programs can be used to convert data from a first database format to a second database format.

### BACKGROUND OF THE INVENTION

The present invention relates generally to methods and apparatus for interfacing application programs with database systems, and more particularly to computer systems and interface layering programs for allowing application programs having a particular database interface to communicate with databases requiring a different database interface.

Many organizations are running mission-critical software applications on mainframe and mid-range computer systems, which include or access old, less functional databases. The old, less functional databases typically store the collected data in formats which are cryptic and non-relational, making it difficult for new applications to access the data, and difficult for the old “legacy” applications to share the data in real-time with newer WEB or Enterprise Resource Planning Applications.

Given the advent of the internet, companies and organizations are finding it beneficial to allow people and other organizations outside the company to access applications and data within the company. For example, many companies are now using the internet to sell products, place orders, communicate with salesmen and vendors, bill customers, as well as many other real-time functions. Similarly, educational organizations now allow students to use the internet to register for classes, obtain billing statements and information, enter financial aid information, obtain grade information, as well as other functions.

While many organizations wish to use the web to improve their business model, a large number of them are having problems implementing web applications because their existing mainframe and/or mid-range computer systems, and in particular their old databases, are not designed to handle these real-time transactions over the web and do not provide non-stop (24 hours a day, 7 days a week) access to information. Therefore, it is desirable for these organizations to convert their exiting data over to new, more functional databases.

A big problem with converting to a new, more functional database is that many times the organizations' existing applications, which typically are written in “legacy” computer languages, such as COBOL, RPG, and the like, will not interface with the new data base format and required query language. One solution to this problem is for the organization to scrap their old system(s) and start new. Unfortunately, however, this can be very expensive and time consuming. Thus, the best solution for many organizations is to adapt their existing legacy application programs to the new database format. Therefore, what is needed is an interface which allows the old legacy application programs to access and communicate with the new database(s).

In addition, in some instances, organizations choose to convert their old individual computing sub-systems to large “enterprise” systems designed to handle every aspect of the organization. For example, instead of having individual sub-systems for order processing, inventory control, financials, etc., the new, large enterprise systems are designed to integrate the functionality of all these sub-systems into a single omnibus system. Companies providing “enterprise systems” include SAP, PeopleSoft, Oracle, J. D. Edwards, as well as many custom systems developed by system consulting organizations. However, the problem with these enterprise systems is that they take years to develop, and once developed, it is difficult to convert important organizational data from the old systems to the new enterprise system. Therefore, what is needed is a system which can operate while the new enterprise system is being developed, and while operating, can convert the old system data to the new enterprise system data format.

### SUMMARY OF THE INVENTION

According to the invention, a system for interfacing application programs with a database. The system preferably comprises at least one application program adapted to communicate with a first database type, a database of a second database type, and a layering application program in communication between the at least one application program and the database of a second database type. Preferably, the layering application program is for facilitating communication between the at least one application program and the database of a second database type.

In accordance with one embodiment of the present invention, the at least one application program is adapted to access data in a database of the first database type using first database access commands adapted for communication with the first database type. In addition, the database of a second database type preferably is accessed by application programs using second database access commands adapted for communication with the second database type. In accordance with this particular embodiment of the present invention, the layering application program preferably converts the first database access commands from the at least one application program to the second database access commands, so that the at least one application program can access data in said database of the second database type.

In accordance with another embodiment of the present invention, a layering application program can be used to convert data from a first database format to a second database format.

In accordance with yet another embodiment of the present invention, a novel layering program development and data conversion methodology is used to create the layering application program and data conversion components of the present invention.

In accordance with yet another embodiment of the present invention, a layering application program is used to interface web-based applications to a database.

In accordance with yet another embodiment of the present invention, one or more layering application programs are used to synchronize data in a plurality of databases.

A more complete understanding of the present invention may be derived by referring to the detailed description of preferred embodiments and claims when considered in connection with the figures, wherein like reference numbers refer to similar items throughout the figures.

### BRIEF DESCRIPTION OF THE DRAWINGS

FIG. 1 is a block diagram illustrating an old legacy computer subsystem, in which the legacy application programs communicate with an old, non-relational database;

FIG. 2 is a block diagram illustrating the legacy computer subsystem of FIG. 1, in which the legacy application programs are now communicating with a new relational database via an interface layer application;

FIG. 3 is a block layout of a typical COBOL data structure;

FIG. 4 is a diagram of a mapping spreadsheet used to map the layout of record 1 of the data structure of FIG. 3 to a new data base format;

FIG. 5 is a diagram of a mapping spreadsheet used to map the layout of record 2 of the data structure of FIG. 3 to a new data base format;

FIG. 6 is a diagram of a mapping spreadsheet used to map the layout of record 3 of the data structure of FIG. 3 to a new data base format;

FIG. 7 is block diagram illustrating the output of a code generator of the present invention;

FIG. 8 is block diagram illustrating the components of a logic I/O routine created by the code generator of FIG. 7;

FIG. 9 is a block diagram of a computer subsystem using an interface layer application for bi-directional communication with a new database;

FIG. 10 is a block diagram of a computer subsystem using an interface layer application for unidirectional communication with a new database;

FIG. 11 is a block diagram illustrating a computer subsystem using an interface layer application for bi-directional communication between legacy application programs and a new database, as well as web applications communicating with the new database;

FIG. 12 is a block diagram of the subsystem of FIG. 11 further including enterprise solution applications and database;

FIG. 13 is a block diagram of a computer system, in which the entire interface layer application resides on one processing machine;

FIG. 14 is a block diagram of a computer system, in which the functions of the interface layer application are divided across multiple processing machines; and

FIG. 15 is a block diagram of a computer system, in which interface layer applications are used to convert multiple independent computer subsystems into a single enterprise wide computer system.

### DESCRIPTION OF THE SPECIFIC EMBODIMENTS

The present invention relates to a system and applications for converting an organization's data to a new flexible database, and for providing an interface layer which allows the organizations' existing “legacy” application programs to interface with the new database. In addition, the system can be configured to interface enterprise system applications and web-based applications with the new database or an enterprise system specific database. In accordance with this aspect of the present invention, the interface layer preferably includes data conversion programs, application interface programs, error checking programs, and the like. As discussed in greater detail below, the interface layer can be embodied in hardware, software, or a combination of both.

For clarity purposes, the present invention described will be described herein with reference to an educational processing subsystem, which includes a number of application modules, such as a degree audit module, a student grades module, a financial aid information and processing module, a class registration module, a student billing module, and a student records module, to name a few. However, one skilled in the art will appreciate that the present invention can be used to interface any number of systems or subsystems to a particular database, such as financial systems, order processing systems, security systems, human resources systems, inventory control systems, etc. Thus, the present invention is not limited to the illustrated and described embodiments.

In the figures, similar components and/or features have the same reference label. Various components of the same type are distinguished by following the reference label by a dash and a second label that distinguishes among the similar components. If only the first label is used, the description is applicable to any one of the several similar components.

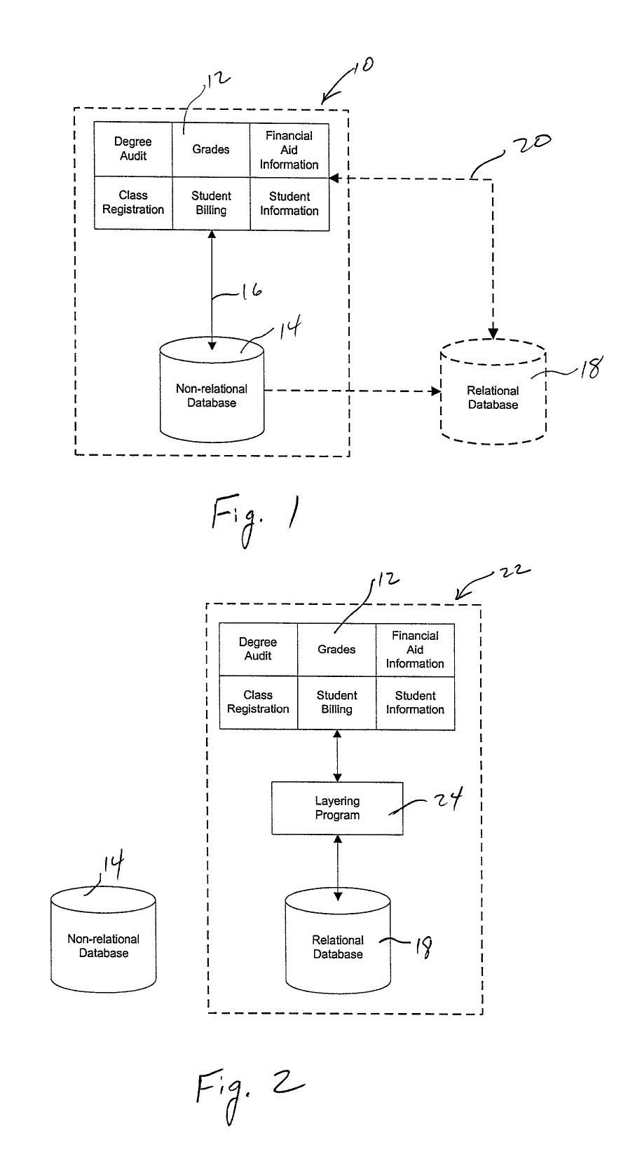

Referring now to FIG. 1, a conventional computer processing system or subsystem 10 is shown. In accordance with the illustrated embodiment, system 10 comprises a plurality of application programs or modules 12 which access a database 14 via some form of communication means 16. As one skilled in the art will appreciate, application programs or modules 12 may reside on and be processed by any type of computer processing system. For example, suitable computer processing systems may include a mainframe computer system, a mid-range computer system, a RISC processor based computer system, a conventional PC system, or any other suitable processing system currently known or hereinafter developed. In addition, database 14 may reside on internal storage of the computer processing system, or database 14 may be stored on external storage devices, such as optical or magnetic disk drives, tape drives, RAID storage devices, file servers, database servers, or the like.

As one skilled in the art will appreciate, newer, more functional databases are always being developed. Currently, many organizations with older computer systems are utilizing old, less-functional databases, such as IBM's VSAM database, DEC's VAX RMS database, or the UNIX based C-ISAM database, to name a few. In many instances, due to the non-functional nature of these databases, only on-line or batch programs can access and process data in the databases. Real-time sharing and 24 hour a day, 7 day a week access of the data, whether via online mainframe or mid-range applications, web-based applications, or client-server based applications, is not possible with the old databases, severely limiting the business functionality of the organization. Therefore, many organizations want to convert their existing data to newer, more functional databases, without having to rewrite or replace all of their existing application programs. Thus, as illustrated in FIG. 1, it is desirable to convert an organization's data from an old database format 14 to a newer database format 18, and have application programs 12 interface with new database 18, for example, via interface means 20.

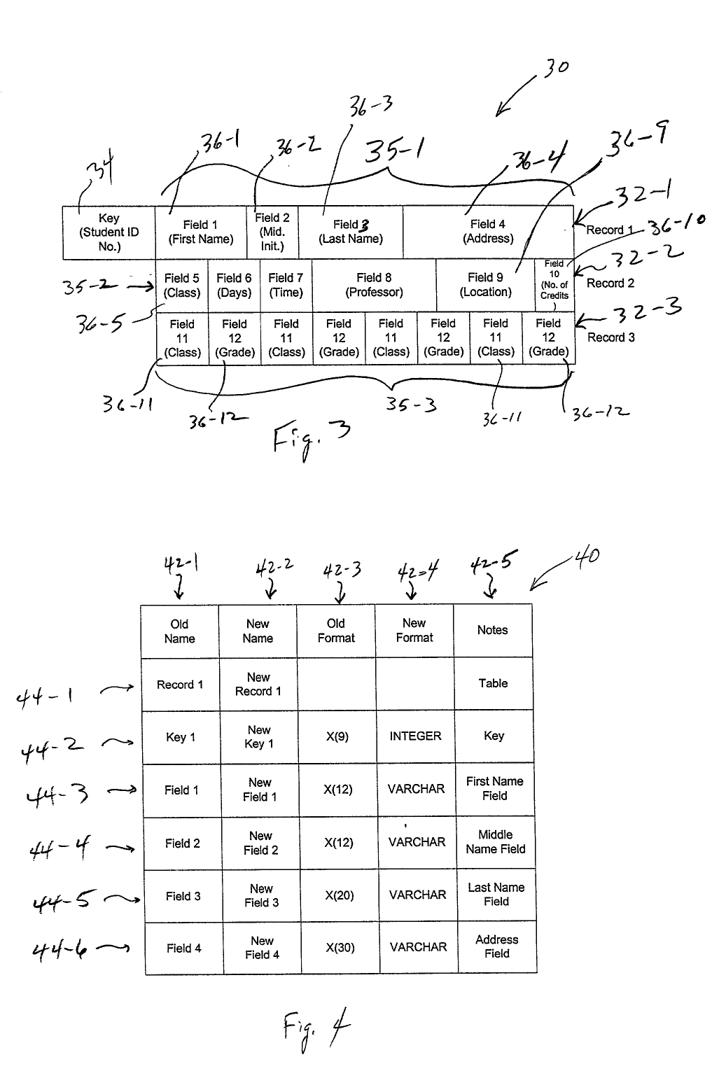

Once new database 18 is in place and the organization's data is converted to the new database format, the organization will essentially have a new back-end system. For example, as illustrated in FIG. 2, system 22 comprises old “legacy” application programs 12 interfacing with new database 18. However, since legacy application programs 12 typically are not designed to interface with the new database 18, an interface layer 24 is used to facilitate the communication between legacy applications 12 and database 18. As illustrated in FIG. 2, once the new database 18 is in place, old database 14 preferably is cut off from the new system and not used.

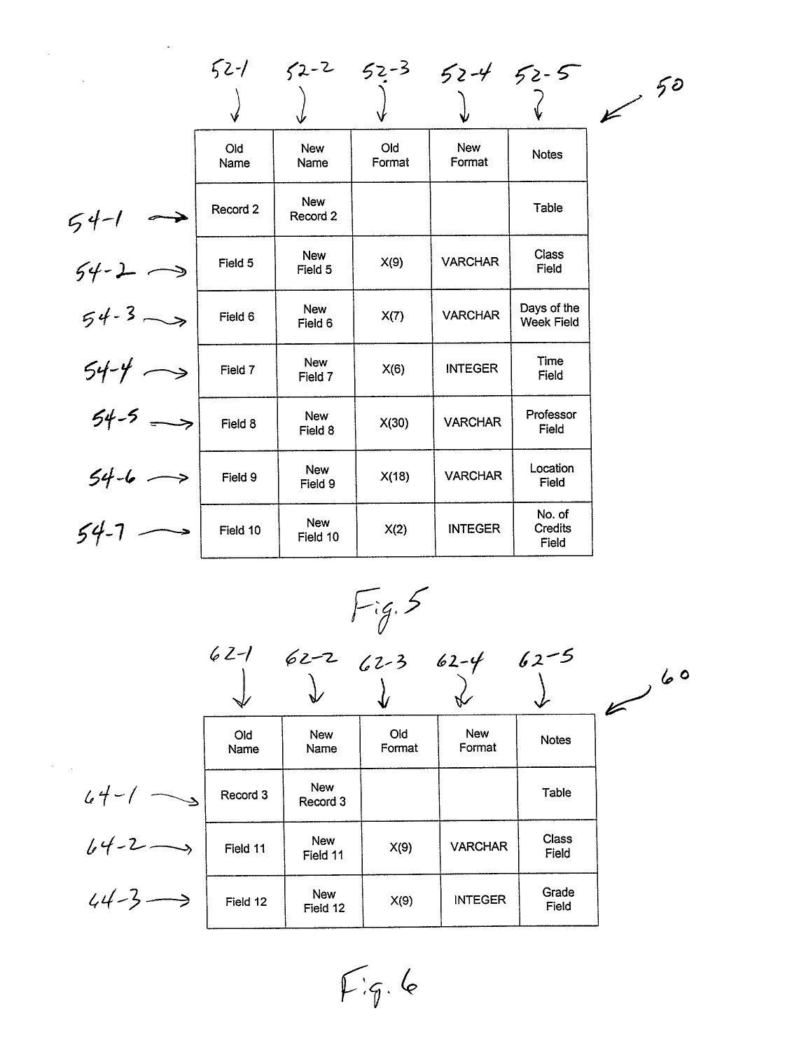

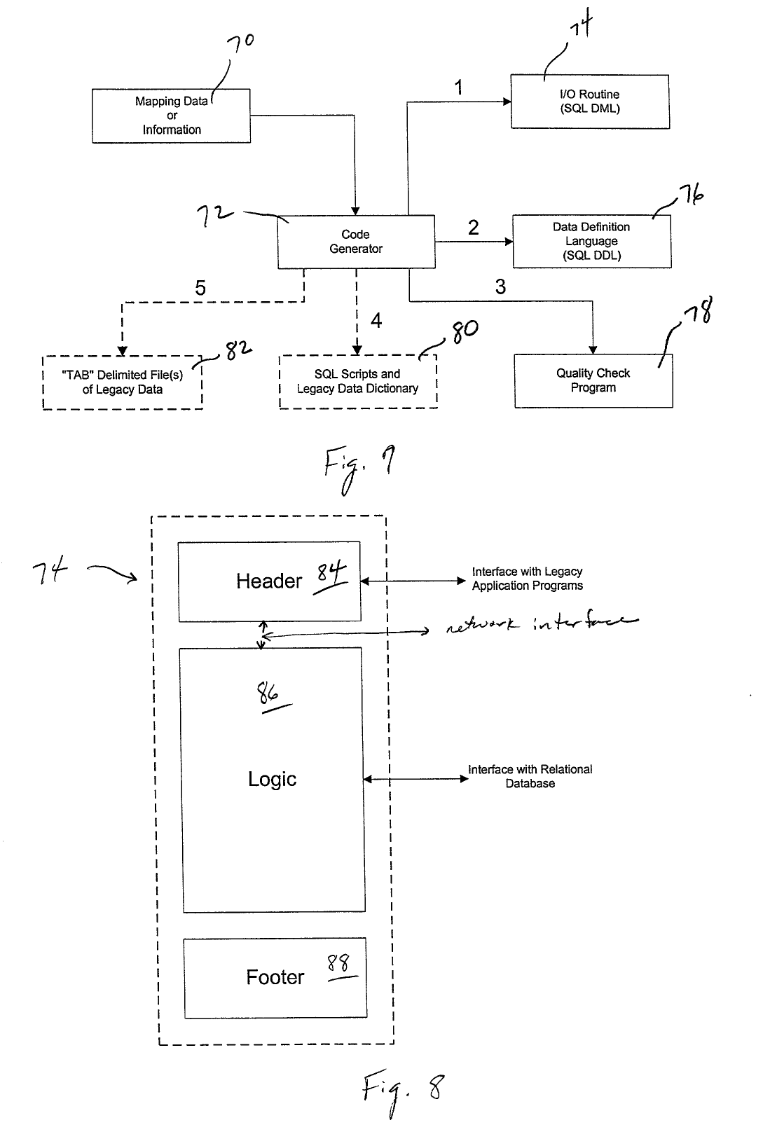

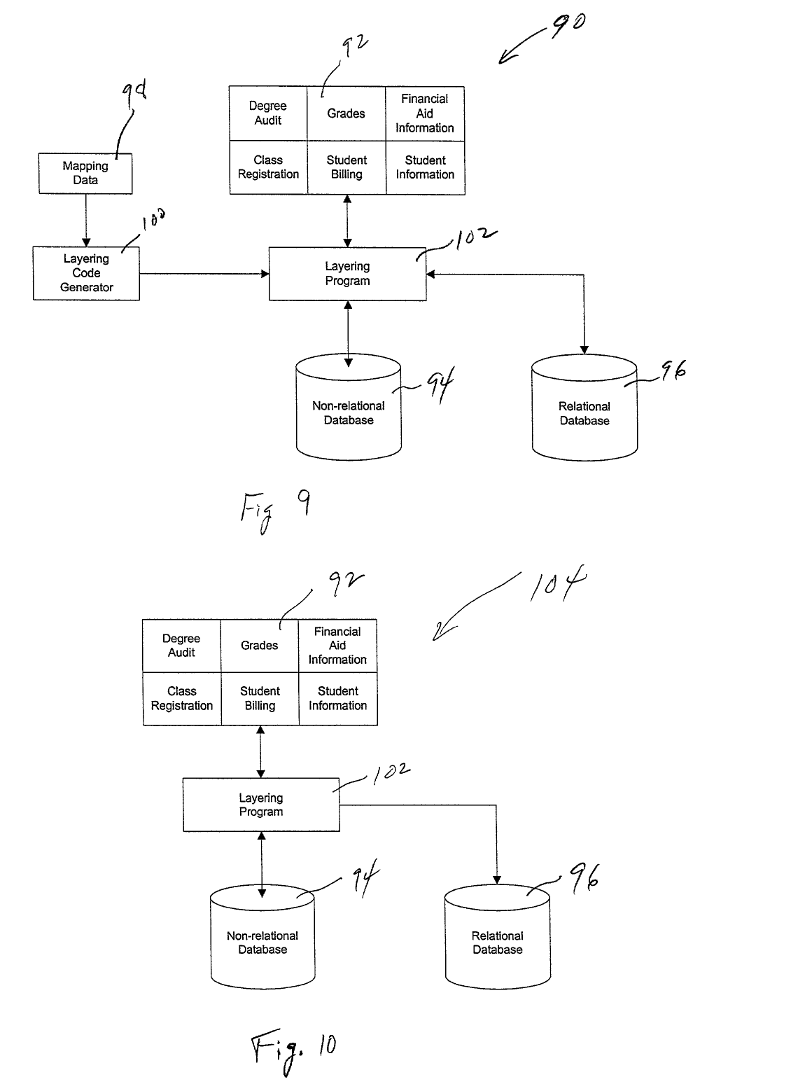

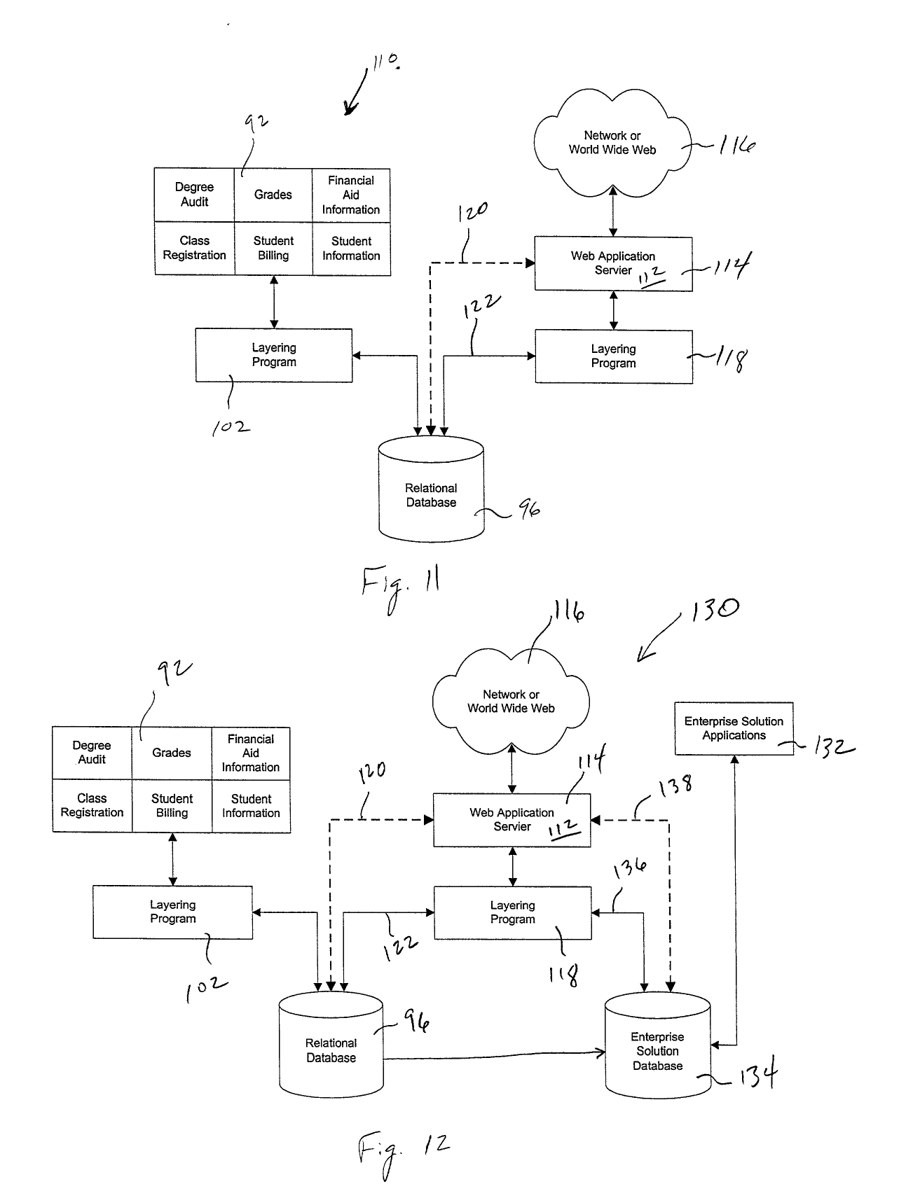

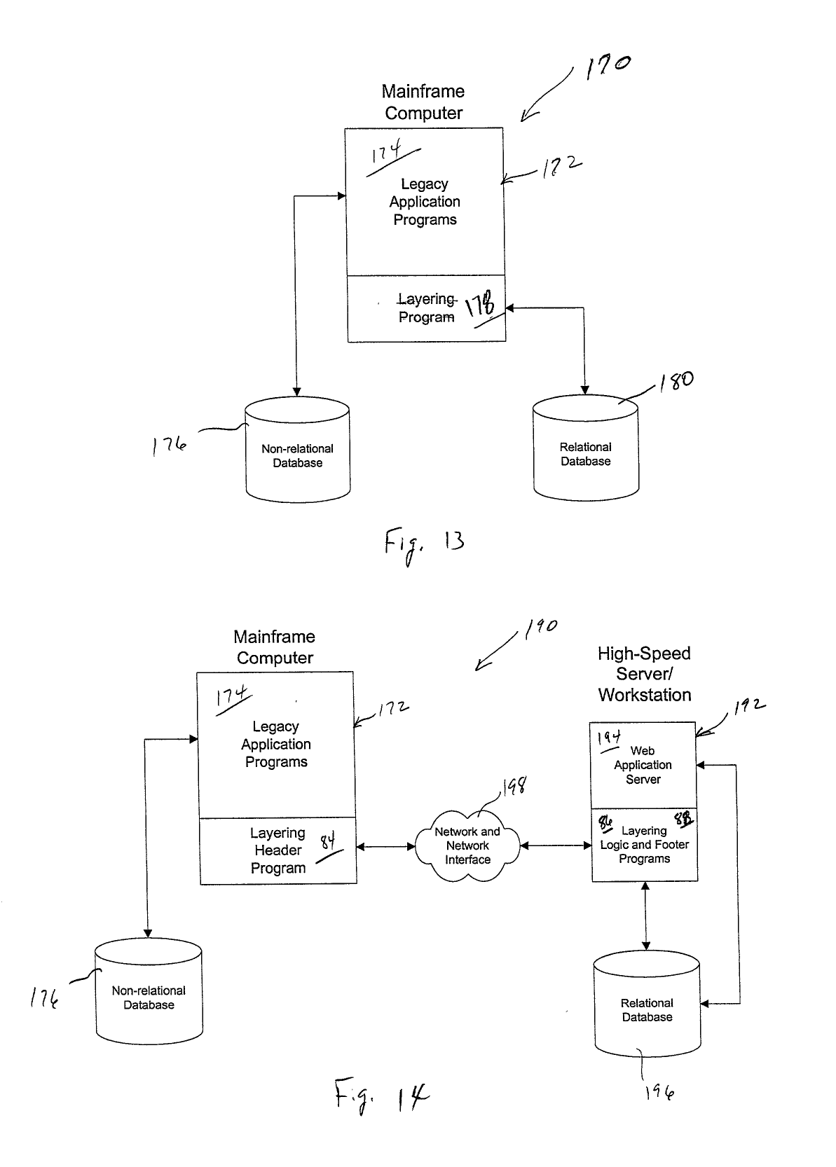

With non-relational type databases, records typically are written to data files in a database using a key as the identifier for the record. When reading records from a data file, the value in the key field is used to select the appropriate record(s). The record(s) then are placed in an application program data structure, for example one similar to data structure 30 which is illustrated in FIG. 3. The program data structure divides the record into appropriate data fields, which are then used by the program, for example to modify values in a record, write new records to a file, or prepare and write reports using the data field values.

Referring now to FIG. 3, a typical COBOL data structure 30 is shown. As illustrated in FIG. 3, data structure 30 comprises 3 record descriptions, 32-1, 32-2, and 32-3. The first record 32-1 of data structure 30 comprises a key 34 and a record body 35-1 having a plurality of fields 36. In the illustrated embodiment, body 35-1 of first record 32-1 comprises fields 36-1 to 36-4. Second and third records 32-2 and 32-3, do not include the key field 34, but do have bodies 35-2 and 35-3, respectively, which may or may not be equivalent in length to body 35-1 of first record 32-1. In the illustrated embodiment, body 35-2 of second record 32-2 is divided into fields 36-5 to 36-10, and body 35-3 of third record 32-2 is divided into a plurality of fields 36-11 and 36-12.

In accordance with the present invention, the first step in installing a new database typically is to convert the data in the old database to the new database format. In particular, data records which are in the old database file format are converted to a new file format compatible with the new database structure. Preferably, standard normalization and conversion rules are followed. For example, in accordance with one embodiment of the present invention, the old database file and record formats and the legacy application programs are studied to determine the particular data record formats for each data file. Then, a spreadsheet or other suitable mapping method is used to map the old database data record formats to the new database record formats. For example, as illustrated in FIGS. 4-6, records 32-1, 32-2, and 32-3 are mapped to new record formats; FIG. 4 illustrates the mapping of first record 32-1, FIG. 5 illustrates the mapping of second record 32-2, and FIG. 6 illustrates the mapping of third record 32-3.

Referring specifically to FIG. 4, an example of the mapping function will now be discussed. Preferably, a spreadsheet 40, such as lotus, excel, quatro pro, or the like, is used to map each record and the keys and fields of each record to a new record format. As shown in FIG. 4, one embodiment of spreadsheet 40 used to map old records to new record formats includes 5 columns; 42-1 to 42-5. Preferably, the first column 42-1 includes the old name of the record, key, and/or field. Similarly, the second column 42-2 includes the new name of the record, key and/or field; the third column 42-3 includes the old key or field format; the fourth column 42-3 includes the new key and/or field format; and the fifth column 42-5 includes notes and attributes for each record, key, and/or field.

Each row of spreadsheet 40 preferably corresponds to a record, key, and/or field. For example, a first row 44-1 of spreadsheet 40 corresponds to the title or label of first record 32-1. As illustrated in FIG. 4, row 44-1 corresponding to the record name for first record 32-1 does not include old and new formats for the record. The old and new formats for the record are defined by the subsequent key and field information as set forth in rows 44-2 to 44-6.

In accordance with the illustrated embodiment, the mapping of second record 32-2 is set forth in spreadsheet 50 illustrated in FIG. 5, and the mapping of third record 32-3 is set forth in spreadsheet 60 illustrated in FIG. 6. The general form of spreadsheets 50 and 60 is similar to the form of spreadsheet 40. However, since the key 34 of data structure 30 is only defined in first record 32-1, the mapping information for key 34 is only included in spreadsheet 30, not spreadsheets 40 and 50. In addition, as one skilled in the art will appreciate, the five (5) column format of the spreadsheets illustrated in FIGS. 4-6 and described herein is only an example of a preferred spreadsheet format. More or less columns may be used in the mapping spreadsheets, depending on the desired detail of the mapping.

Once the mapping spreadsheets for each record are prepared, the mapping data or spreadsheet information is input into a code generator, which generates the interface layer application program, as well as other information needed to convert the data from the old database format to the new database format and to facilitate the communication between the legacy application programs and the new database.

Referring now to FIG. 7, the code generation process will now be discussed. In accordance with a preferred embodiment of the present invention, mapping data information 70, which is generated by preparing mapping spreadsheets, such as spreadsheets 40, 50 and 60, is input into a code generator 72. In turn, code generator 72 preferably creates a logic I/O routine 74, a data definition language 76, and a quality check program 78 for each data file. In addition, in accordance with another preferred embodiment of the present invention, code generator 72 may be configured to create a legacy data dictionary 80 and a legacy data file 82, which, as discussed below, typically is used to generate new enterprise databases.

The logic I/O routines 74 preferably are programming routines which allow the legacy application programs to communicate with the new database. For example, if the new database is a typical relational database, such as DB2, Sybase, Oracle, Iformix, or the like, the logic I/O routines 74 preferably comprise the logic required to communicate with the database; i.e., a suitable SQL data management language (DML) for communicating with the database. As one skilled in the art will appreciate, if other types of databases are used, the logic I/O routines 74 will include the logic necessary to interface the legacy application programs to those other databases.

Referring now to FIG. 8, a simple block diagram of a suitable logic I/O routine 74 is shown. As illustrated in FIG. 8, logic I/O routine 74 preferably comprises a header 84, a logic portion 86, and a footer 88. Header 84 includes the program identification information and preferably is adapted to communicate directly with the legacy application programs.

Logic portion 86 of I/O routine 74 is adapted to communicate with the database and preferably includes the logic necessary to communicate with the database. For example, logic portion 86 includes the programming logic which will facilitate data record reads, inserts, updates, deletes, etc. In addition, logic portion 86 includes error checking and clean-up logic which ensures that data written from a program to the database, and data read from the data base into a program is valid data and properly justified in the fields.

Finally, footer 88 includes the logic necessary to process database access error routines. For example, if a program tries to update a record in the database that is currently in use, an error will occur and the logic in footer 88 will format the proper error code to be passed to the program. The program includes logic to interpret the error code and perform the proper error recovery routines. Similarly, footer 88 will handle the error processing when read, write, delete and other database access errors occur.

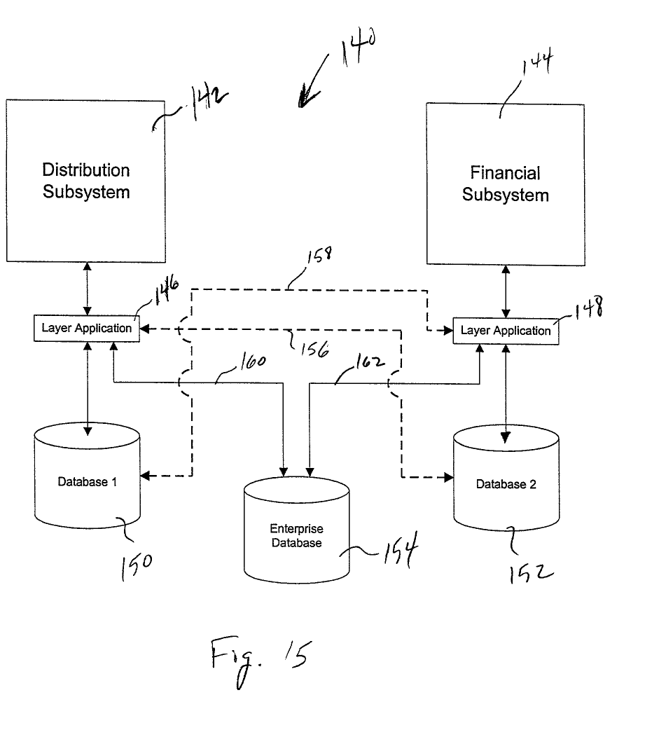

As illustrated in FIG. 8, header 84, logic portion 86, and footer 88 all makeup I/O routing 74. However, while it appears that header 84, logic portion 86, and footer 88 all reside on the same machine, it is not required. For example, referring now to FIGS. 13 and 14, two embodiments of location and configuration of I/O routine 74 are shown. In particular, in FIG. 13, a system 170 is shown in which an application layer 178 resides on the same machine 172 as legacy application programs 174. As illustrated in FIG. 13, machine 172 may comprise a mainframe computer, a mid-range computer, or any other suitable processing machine. As discussed above with reference to FIG. 7, application layer 178 preferably comprises I/O routines 74, one or more data definition languages 76, and quality check programs 78. In this particular embodiment illustrated in FIG. 13, all portions of I/O routines 74 preferably reside on machine 172. That is, header 84, logic portion 86, and footer 88 all are run on machine 172. In this manner, when the data is converted from the old, non-relational database 176 to the new relational database 180, application layer 178 is used to facilitate the communication between legacy application programs 174 and the new relational database 180.

In accordance with another embodiment of the present invention, it may be desirable to divide the application layer onto separate machines. Such a configuration is illustrated in FIG. 14. In accordance with the embodiment illustrated in FIG. 14, a system 190 is shown which includes a first computer 172 which stores and runs legacy application programs 174. In addition, a second computer 192, such as a high-speed server or work station is shown which includes a plurality of web based applications 194. Web based applications 194 preferably are configured to communicate directly with a new relational database 196. In accordance with this embodiment of the present invention, it is desirable for legacy application programs 174 to also communicate with relational database 196. Thus, an application layer is used to facilitate the communication between legacy application programs 174 and relational database 196 over a network connection or interface 198. In accordance with this aspect of the present invention, an application layer header program 84 preferably resides on first computer 172, while application layer logic and footer programs 86 and 88, respectively preferably reside on the second computer 192. In this manner, application layer header program 84 interfaces with application layer logic and footer programs 86 and 88 to complete the application layer functionality. In addition, data definition language 76 and layer quality check programs 78 also preferably reside on second computer 192 and are used by logic and footer programs 86 and 88.

Data definition language (DDL) 76 preferably comprises a data file having the file, record and field definitions for each file in the new database. DDL descriptions 76 are used to create the database and by the logic portion 86 of logic I/O routine to interface with the database. For example, logic portion 86 preferably will access DDL descriptions 76 to format the data or data structure when accessing the database.

Layer quality check programs 78 may comprise either batch or online programs and preferably are configured to run over the new database to check the integrity of the data in the new database. For example, the layer quality check programs 78 will detect data justification errors, data value errors, and the like.

As discussed in more detail below, SQL scripts and legacy data dictionary 80 can be used by an enterprise solution developer to create the data dictionary for the enterprise database. In addition, the legacy data files 82 generated by code generator 72 can be used to transfer data to the new enterprise database. For example, code generator 72 can create a legacy data file 82, such as a TAB delimited file or the like, which has the same general file format as the new enterprise database. Thus, data can be loaded into the legacy data file 82 and then easily downloaded into the enterprise database. In this manner, the legacy data file 82 acts as a data format converter.

Referring now to FIG. 9, a subsystem 90 is shown in which an interface layer application 102 is used to convert data from an old database 94 to a new database 96, and to facilitate communications between legacy application programs 92 and the new database 96. As discussed above, interface layer applications 102 are created for each data file by a code generator 100, which uses mapping data 98 to create the layer. Once the interface layer applications 102 are generated, they are used to convert data from the old database 94 to the new database format 96. Preferably, the data conversion process only occurs the first time the legacy application programs 92 are run. In accordance with this aspect of the present invention, the first time the legacy applications 92 are run, the layering application programs access the data in old database 94 using interface layer 102. Once the data has been read from old database 94, it then is written back to new database 96 using interface layer 102 to facilitate the communication between the legacy application programs 92 and new database 96. As shown in FIG. 11, after the data has been written to new database 96, old database 94 can be removed from the system, and legacy application programs will communicate bi-directionally with new database 96 via interface layer 102.

In accordance with another embodiment of the present invention, interface layer 102 can be used only as a unidirectional data conversion application as illustrated in FIG. 10. In accordance with this embodiment of the present invention, a computer system 104 preferably comprises legacy application programs 92, an old database 94, a new database 96 and an interface layer 102. Legacy application programs 92 preferably communicate with old database 94 via interface layer 102. In addition, as application programs 92 use interface layer 102 to access and update data in old database 94, the interface layer 102 also writes the data to new database 96. For example, when application programs 92 execute I/O functions on the old database 94, interface layer 102 will check to see if that function needs to be performed on the new database 96. When true, interface layer 102 preferably will execute the functions to the new database 96. Similarly, as records are written to and updated on old database 94, interface layer 102 also writes the new and updated records to new database 96 in the new database format. In this manner, the data in new database 96 preferably will be a mirror copy of the data in old database 94, except that the data will be in the proper form for the new database. This uni-directional interface layer allows the real-time conversion of data from old database 94 to new database 96.

Referring now to FIG. 11, a system 110, which includes web-based applications is shown. As mentioned above, it typically is not possible to develop real-time web-based applications which will interface with the old, non-relational type databases. Thus, as discussed above with reference to FIG. 9, it is beneficial for organizations to convert their data over from old, non-relational database formats to newer, more functional relational type databases. Once converted to the new database format, web-based applications can be developed to access data in the new database.

In accordance with this aspect of the present invention, system 110 preferably comprises legacy application programs 92, a first application layer 102, a database 96, web applications 112, which preferably reside on a web server 114 and are accessible via a network 116, and a second application layer 118.

As discussed above with reference to FIG. 9, legacy applications 92 preferably access database 96 via application layer 102. In addition, in accordance with this particular embodiment of the present invention, individuals within an organization, as well as people outside an organization can access data on database 96 using web applications 112. For example, with an education system, such as the one described herein as an example, a student can use the internet to access grade information, schedule classes, obtain billing information, and perhaps even pay bills. To do this, the student connects to server 114 through network 116 and uses web applications 112 on server 114 to retrieve and/or update data on database 96. Preferably, web applications 112 are Java applets or other similar web-enabled applications which communicate with database 96 to retrieve and update the necessary data. Web applications 112 can communicate either directly with database 96, for example via path 120, or via a second application layer 118 which uses path 122.

Second application layer 118 preferably is similar to the other application layers described herein. That is, application layer 118 facilitates communications between web applications 112 and database 96, as well as performs all necessary formatting and error checking functions. Finally, as one skilled in the art will appreciate, network 116 can be a local area network, a wide area network, or the internet.

Referring now to FIG. 12, yet another embodiment of the present invention is shown. In accordance with this particular embodiment of the present invention, a system 130 is similar to system 110 illustrated in FIG. 11, except that system 130 includes an enterprise resource planning database 134 and enterprise solution applications 132. That is, in addition to relational data base 96, legacy application programs 92, and web applications 112, system 130 preferably further includes a new enterprise wide database 134 and associated applications 132.

As discussed above, some organizations determine that it is best to change their systems from their old legacy applications and old database structures to a new enterprise solution which integrates all aspects of the organization into one large system. However, converting to an enterprise wide solution can take a long time. For example, an average conversion to an enterprise application is between about 12 and about 18 months. Thus, it is desirable for the organization to be able to utilize their Legacy application programs 92 and web-based applications 112 while the enterprise solution is being developed. Thus, as shown in FIG. 12, system 130 is configured for such an application. In accordance with system 130 in FIG. 12, Legacy application programs 92 and web-based applications 112 are configured to access data on relational database 96. In this manner, while enterprise applications 132 and the enterprise database 134 are being developed, the organization can continue to function using its old legacy applications 92, as well as new web-based applications 112 as discussed above with reference to FIG. 11.

After the enterprise applications 132 and enterprise database 134 are finalized, the data in relational database 96 preferably is converted to the new enterprise database 134 format or kept synchronized. This can be accomplished using conversion programs, a layer application, such as the one discussed above with reference to FIG. 10, or a legacy data file, such as the one discussed above with reference to FIG. 7.

Once the data is converted over, web applications 112 on web server 114 preferably are modified to communicate with the new enterprise database 134. In accordance with this aspect of the invention, an application layer 118 may be used to facilitate communications between web applications 112 on web server 114 and enterprise database 134, for example using path 136. Alternatively, web applications 112 may be configured to communicate directly with enterprise database 134, for example, via path 138. As one skilled in the art will appreciate, if web applications 112 initially are written to communicate directly with relational database 96, via path 120, then application layer 118 preferably is used to facilitate the communication of web applications 112 with enterprise database 134 via path 136. Conversely, if web applications 112 initially are written to communicate directly with enterprise database 134, via path 138, then layering program 118 preferably is used to facilitate communication between web applications 112 and relational database 96 via path 122. Once the enterprise solution applications 132 are in place and communicating with enterprise database 134, the use of Legacy applications 92 and relational database 96 can be discontinued.

Referring now to FIG. 15, yet another embodiment of the present invention is illustrated. In accordance with this particular embodiment of the present invention, a system 140 is shown in which layering application programs can be used to interface independently functioning subsystems to create an enterprise solution. For example, an organization may have a plurality of subsystems, such as financials, inventory control, order processing, human resources, etc., each of which may have its own database. Thus, it is desirable to have all the independent subsystems share the same data, or at least have the data on the independent databases be consistent. This is the essence of an enterprise solution.

System 140 preferably comprises a plurality of subsystems. In accordance with the illustrated embodiment, system 140 is shown as having a distribution subsystem 142 and a financial subsystem 144. However, other subsystems may be, and preferably are included. As shown in FIG. 15, distribution system 142 preferably is configured to communicate with a first database 150 via a first application layer 146. Similarly, financial subsystem 144 preferably is configured to communicate with a second database 152 via a second application layer 148. Preferably, first database 150 and second database 152 are relational-type database such as DB2, Oracle, Sybase, or the like.

In order to unify the separate subsystems 142 and 144 into an enterprise solution, distribution system 142 preferably utilizes first application layer 146 to communicate with second database 152, for example via path 156. Similarly, financial subsystem 144 preferably utilizes second application layer 148 to communicate with first database 150 via path 158. As one skilled in the art will appreciate, by integrating the separate subsystems 142 and 144 so that they communicate with all the databases in the system, data consistency on all databases can be maintained. Thus, when distribution 142 updates information on database 150, it also will update similar information on database 152 to the extent that the data is redundant. For example, if distribution system 142 updates a company address, that address will be updated on all databases, thus maintaining data consistency on the databases.

In addition, in accordance with another embodiment of the present invention, system 140 can be configured with a single enterprise wide database 154 instead of multiple databases for each subsystem. Thus, in accordance with this aspect of the present invention, application layers 146 and 148 can be used to facilitate communication between the various subsystems and enterprise database 154. That is, application layer 146 preferably facilitates communication between distribution subsystem 142 and enterprise database 154 via path 160, and application layer 148 preferably facilitates communication between financial subsystem 144 and enterprise database 154 via path 162. Thus in accordance with this embodiment of the present invention, a single enterprise database 154, where common data is stored, can be utilized without developing entirely new enterprise applications. The Legacy applications from the old subsystems can be used to interface with the new database.

In conclusion, the present invention provides methods and apparatus for interfacing application programs with database systems. While a detailed description of presently preferred embodiments of the invention have been given above, various alternatives, modifications, and equivalents will be apparent to those skilled in the art. For example, while an education subsystem is described herein as an example, one skilled in the art will appreciate that other subsystems and well as multiple subsystems may be used without varying from the spirit of the invention. Therefore, the above description should not be taken as limiting the scope of the invention which is defined by the appended claims.

What is claimed is:

1. A system for interfacing application programs with a database, comprising:
at least one application program adapted to access data in a database of a first database type using first database access commands adapted for communication with said first database type;
a database of a second database type, which is accessed by application programs using second database access commands adapted for communication with said second database type; and
a layering application program in communication between said at least one application program and said database of a second database type, said layering application program for converting said first database access commands from said at least one application program to said second database access commands, so that said at least one application program can access data in said database of a second database type.

2. A system for interfacing application programs with a database, comprising:
at least one application program adapted to communicate with a first database type;
a database of a second database type; and
a layering application program in communication between said at least one application program and said database of a second database type, said layering application program for facilitating communication between said at least one application program and said database of a second database type.
